(19) United States
(12) Patent Application Publication
(10) Pub. No.: US 2013/0185364 A1
(43) Pub. Date: Jul. 18, 2013

(54) EMAIL APPLICATIONS

(71) Applicant: Rajesh BHATIA, Bangalore (IN)

(72) Inventor: Rajesh BHATIA, Bangalore (IN)

(21) Appl. No.: 13/353,021

(22) Filed: Jan. 18, 2012

(51) Int. Cl. G06F 15/16

(52) U.S. Cl. 709/206

(57) ABSTRACT

A machine-readable storage device contains machine-readable instructions that, when executed by a processor, cause the processor to perform various actions including, for example, receiving an email message destined for an email printer, selecting an ad based on a parameter contained in the email message, inserting the selected ad into the email message, and transmit the email message for printing. Other embodiments are directed to executing a particular application based on an email address, while yet other embodiments are directed to rerouting an email message.

### BACKGROUND

Email printing permits a device lacking printing capability (e.g., a smart phone without a printer driver) to cause a document to be printed to an email printer. An email printer is assigned an email address. The user's device initiates a print job to print a document to the email printer. The document to be printed is transmitted in the form of an email message through an email service to the email printer. The email printer receives the email message, interprets the email message to extract the document to be printed, and prints the document.

### BRIEF DESCRIPTION OF THE DRAWINGS

For a detailed description of illustrative examples, reference will now be made to the accompanying drawings in which:

FIG. 1 shows a system in accordance with various examples;

FIG. 2 provides another example of a system;

FIG. 3 illustrates a data structure in accordance with various examples;

FIG. 4 provides a method in accordance with various examples;

FIG. 5 provides another method in accordance with various examples;

FIG. 6 provides yet a method in accordance with various examples;

FIG. 7 illustrates another data structure in accordance with various examples;

FIG. 8 provides yet a method in accordance with various examples;

FIG. 9 illustrates an example of multiple email applications being executed based on an email message; and

FIG. 10 illustrates another example of multiple email applications being executed based on an email message.

### DETAILED DESCRIPTION

The term “system” refers to a collection of two or more components. A system thus may refer to a single computer system (comprising multiple components such as a processor, memory, etc.), a subsystem of a computer, or a collection of multiple computing devices inter-coupled over a network.

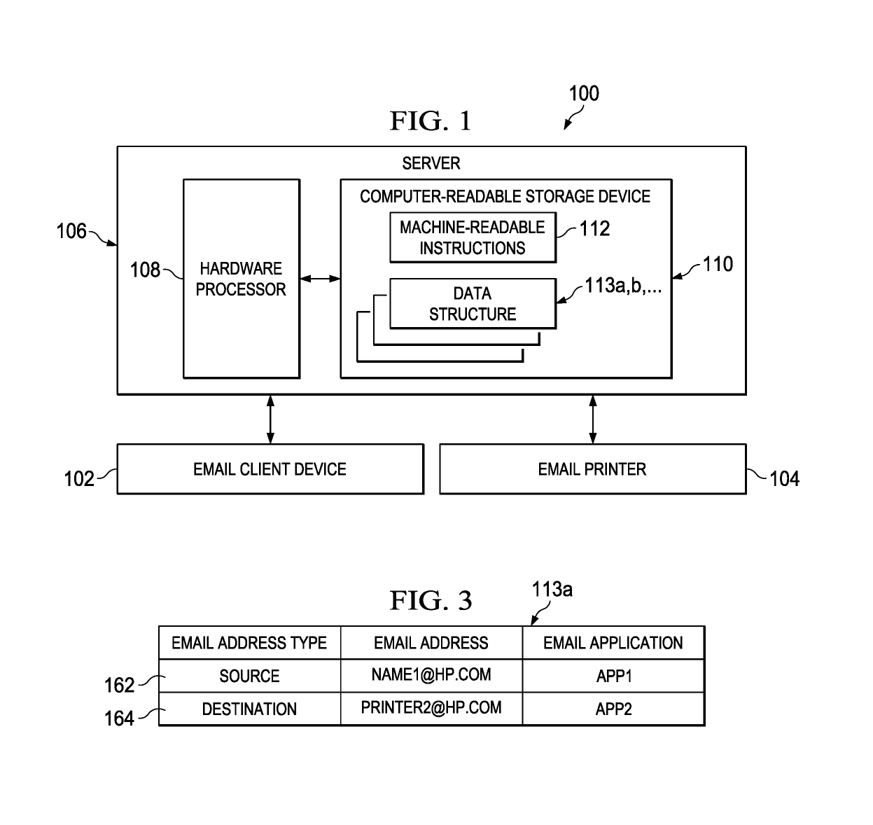

FIG. 1 illustrates a system 100 in accordance with various examples. The system 100 includes an email client device 102 configured to cause an email printer 104 to print information provided by the email client device 102. One or more servers 106 couple to and communicate with the email client device 102 and email printer 104 to implement email printing. Via the email printing service implemented by server 106, multiple email client devices 102 can cause print jobs to be sent to any one of multiple email printers 104.

The email client device 102 may comprise a smart phone, a tablet computer, or any other type of computing device. In at least some embodiments, the email client device 102 lacks sufficient resources to be able to send a print job directly to a printer. For example, the email client device 102 may lack a printer driver for the target printer 104. The email client device 102 instead causes a job to be printed using an email print service. In other embodiments, the email client device 102 may indeed have sufficient resources to send a print job directly to a printer, but the user of the device 102 nevertheless may want to initiate an email-based print job anyway.

The email printer 104 comprises a printer to which an email address can be assigned. The email client device 102 prints to the email printer 104 by causing an email message, in a predetermined format, to be sent to the email address assigned to the email printer 104. The email message contains the information (e.g., an attached document) to be printed by the email printer 104 and also includes the email printer's assigned email address as a destination email address in the message. The email message that is sent by the email client device 102 may be generated by the client device 102 automatically upon the user of the client device selecting a print function (e.g., selecting “PRINT” from a drop down menu). In other embodiments, the user of the email client device 102 actually composes an email message using an application on the device to be sent to the printer and types in or selects the email address of the target email printer 104.

The user of the email client device 102 may register with an email print service. The registration process may include providing the email address of the email account the user uses to send and receive email messages, as well as the email address assigned to the email printer(s) 104 the user intends to use for email printing. Other information (e.g., name, mailing address, etc.) may be provided as well. The user may register with more than one email print service.

The email message is received by the server 106 from the email client device 102. The server 106 then forwards the email message on to the email printer 104 based on the destination email address in the message. The server 106 comprises a hardware processor 108 coupled to a computer-readable storage device 110 which contains machine-readable instructions 112. The computer-readable storage device 110 comprise non-transitory storage such as a hard drive, random access memory, compact disc read-only memory (CD ROM), etc. The machine-readable instructions 112, upon being executed by the hardware processor 108, imparts the hardware processor 108 and thus the server 106 with some or all of the functionality described herein. In some embodiments, system 100 comprises multiple servers 106 and the machine-readable storage device 110 and machine-readable instructions 112 may be distributed across multiple storage devices 110 and servers 106. The computer readable storage device 110 also contains one or more data structures 113 which are used as explained below. Each data structure 113 may comprise a table, a file, or any other suitable storage type and format for storing information. Various data structures are referenced herein as data structures 113a, 113b, etc. and thus data structure 113 in FIG. 1 encompasses all such data structures.

In accordance with various embodiments, the system 100 executes one or more email applications based on the email message as it is in-route from the email client device 102 to the email printer 104. For example, such email applications may be executed by the server 106 and provide added functionality beyond receiving and forwarding the email message to the email printer 104. In some embodiments, such email applications (“apps”) are not executed on the email client devices 102 or the email printers 104, and instead execute on server 106 that also receives and forwards the email messages to the email printers. Such email apps provide enhanced features and functionality above and beyond email printing alone. Examples of various types of email applications include

| Email application | Description |
|---|---|
| Ad Insertion App | Inserts one or more advertisements (ads) in the |
| | email message to be printed |
| Re-Route App | Re-routes an email message targeting one email |
| | printer to a different email printer |
| Rendering App | Rendering transformation and enhancements based |
| | on user preferences |
| Configuration App | Configures apps or user preferences |

The Ad Insertion App selects one or more ads for insertion in to an email message destined to be printed on an email printer. The particular ad(s) selected may be based on a parameter contained in the email message. The parameter may comprise, as explained below, a source email address of the email account used to originate the email message, or a destination email address assigned to the email printer. The ad selected to be inserted may be inserted as a page to be printed separate from the document being printed. The selected ad may include reward points or a coupon, or be an informational ad. In some embodiments, ads may be selected based on content in the email message, user's preferences, and/or analytics based on past usage.

The Re-Route App causes an email message, originally configured for an email address of a particular email printer 104 to be re-routed to a different email printer. In some embodiment, the Re-Route App replaces the original destination email address in the email message (i.e., the email address of the initially desired email printer) with a different email address assigned to a different email printer. A user, for example, might want to temporarily divert all print requests targeting his home printer to his office printer.

The Rendering App may perform any of a variety of functions such as image enhancement, removing ads from the original email message, etc. The Configuration App may be used to configure scheduling events and other items. The Configuration App may be executed based on the source email address or the destination address as described below. One example of the use of the Configuration App is as follows. A user may send an email message that indicates the user's desire to receive certain content (e.g., a crossword puzzle or other type of game) according to a prescribed schedule (e.g., everyday at 8 AM). The Configuration App causes the desired content to be sent to the user according to the prescribed schedule.

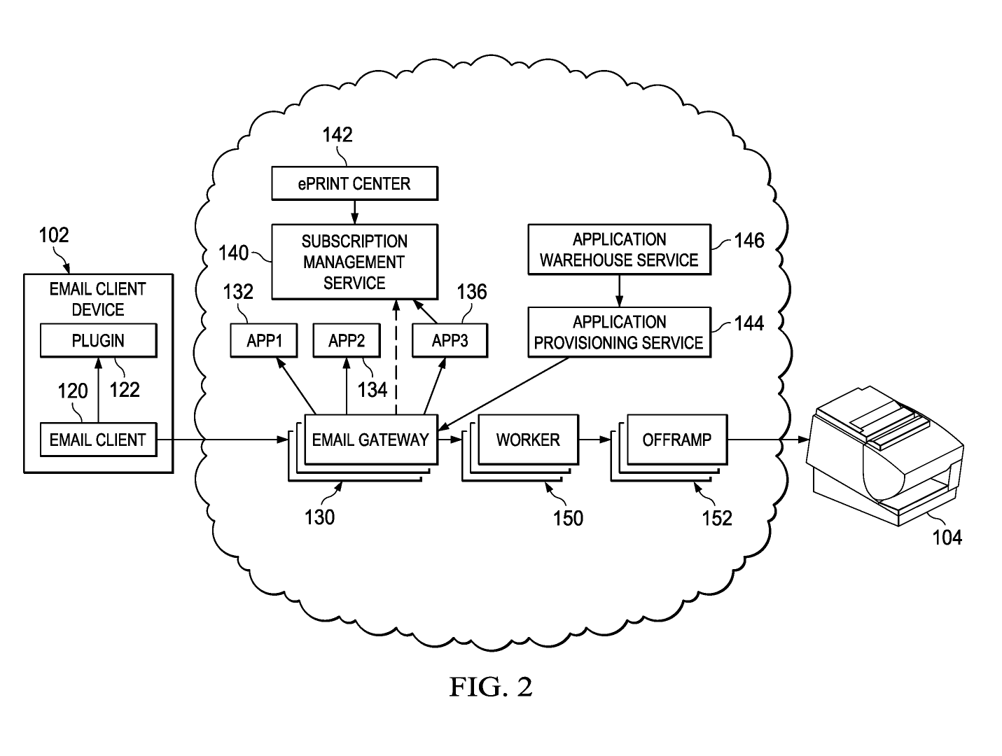

FIG. 2 illustrates a software architecture in accordance with an example. The software on the email client device 102 includes, for example, an email client application 120 and a plugin software module 122. The email client application 120 generates an email message with the email address of the email printer 104 desired by the user. In some embodiments, the email client application 120 runs in a background mode and receives a request from another application running on the email client device 102 by which the user initiates a print job. Alternatively, the user may interact directly with the email client application 120 to create the email message for the email printer 104. The plugin software module 122 interacts with the email client 120 to format the outgoing email message.

At the server level, the software in accordance with various examples includes one or more email gateways 130, one or more email apps 132, 134, and 136, a Subscription Management Service 140, an ePrint Center 142, an App Provisioning Service 144, an App Warehouse Service 146, one or more Workers 150, and one or more Off ramps 152. The machine-readable instructions 112 of FIG. 1 includes one or more of the preceding software items. For example, the machine-readable instructions 112 may include the email apps 132-136, the Subscription Management Service 140, the ePrint Center 142, the App Provisioning Service 144, and the App Warehouse Service 146. Examples of the email apps 132-136 are provided above.

Each email gateway 130 receives the email message using, for example, the Simple Mail Transfer Protocol (SMTP). The email gateway then calls the relevant email app as described herein.

The ePrint Center 142 implements an on-line user interface (e.g., web-based) that permits a user to subscribe to one or more email printing services. Each such email printing service permits the user to print from their email client device 102 to one or more email printers 104. Each user subscribes to an email printing service. The subscription process may include the user specifying the source email address of the email account to be used to originate email-based print jobs, as well as the email address of whichever email printers 104 the user intends to use. Multiple source and/or destination email printer email addresses may be specified by the user to the ePrint Center 142 during the subscription process.

The Subscription Management Service 140 may perform various functions. In some examples, the Subscription Management Service 140 stores a mapping of email addresses and email apps for each user. FIG. 3 illustrates a database 113a (FIG. 1) one such mapping for a particular user. In the example of FIG. 3, the mapping includes two entries 162 and 164. Each entry includes an email address of a type Source or Destination. The Source email address is the address of the email account used to originate the email message. The Destination email address is the email address assigned to the email printer 104 to which the email message is to be sent. The first entry 162 in FIG. 3 contains a source email address. The specific email address in entry 162 is NAME1@HP.COM, and email app APP1 is mapped to that email address. The second entry 164 contains a destination email address (e.g., an email address of an email printer). The specific email address in entry 164 is PRINTER2@HP.COM to which email app APP2 is mapped.

The mapping illustrated in FIG. 3 may be stored in a data structure 113a contained in or accessible to the Subscription Management Service 140. Each user that has subscribed to the email printing service may have his own data structure 113a, or one data structure may store email address-to-email app mappings for multiple users. The use of such data structures 113a is described below.

Referring again to FIG. 2, each email app 132-136 is created, in or otherwise provided to, the App Warehouse Service 146 where each such email app may undergo an approval process (e.g., to ensure that the app functions correctly as intended) before the app is provided to the App Provisioning Service 144. The App Provisioning Service 144 deploys the app to one or more or all of the email gateways 130.

The Workers 150 are responsible for rendering the content in a print ready format. The Off Ramps 152 interface with the printer. The Off Ramps 152 provide the printer with the necessary interfaces required for the print job.

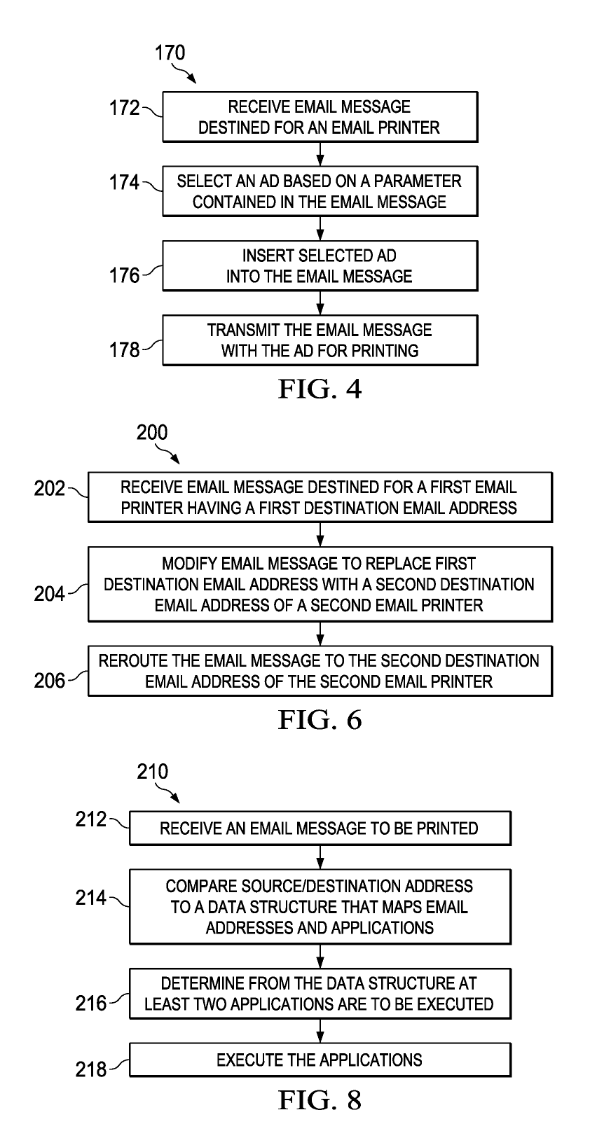

FIG. 4 shows a method 170 in accordance with various embodiments. The method 170 of FIG. 4 implements the Ad Insertion App explained above. The various actions shown in FIG. 4 may be performed by the hardware processor 108 of FIG. 1 upon execution of the machine-readable instructions 112. The actions can be performed in the order shown in FIG. 4, or in a different order, and two or more of the actions can be performed in parallel as desired.

At 172, an email message destined for an email printer 104 is received. The server 106, for example, may receive the email message. The received email message may contain the email address assigned to the email printer 104 as a destination email address.

At 174, method 170 includes selecting an ad based on a parameter contained in the email message. The parameter used to select an ad may be the source email address or the destination email address contained in the email message. The destination email address is the address assigned to the email printer 104 to which the email is to be transmitted. The source email address is the email address of the email account used to generate the email message. More than one ad may be selected.

At 176, the method includes inserting the selected ad(s) into the email message and then, at 178, transmitting the email message with the inserted ad(s) for subsequent printing by the email printer 104 targeted by the destination address in the email message.

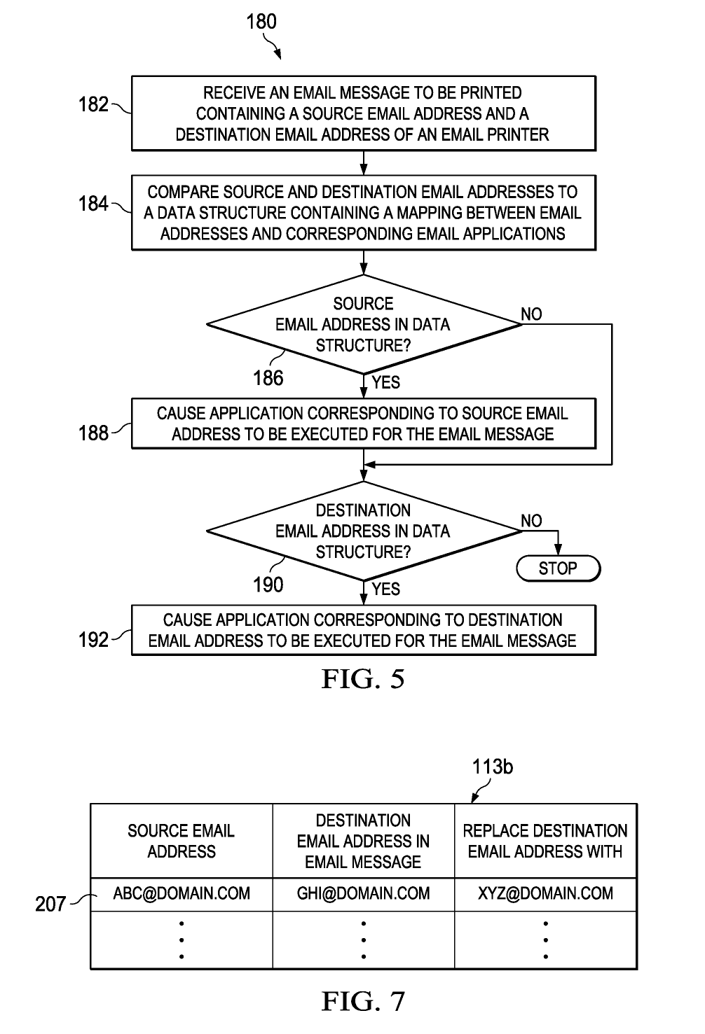

FIG. 5 shows a method 180 in accordance with various embodiments. The various actions shown in FIG. 5 may be performed by the hardware processor 108 of FIG. 1 upon execution of the machine-readable instructions 112. The actions can be performed in the order shown in FIG. 5, or in a different order, and two or more of the actions can be performed in parallel as desired.

At 182, an email message destined for an email printer 104 is received. The server 106, for example, may receive the email message. The received email message contains a source email address and an email address assigned to the email printer 104.

At 184, the method includes comparing the source and destination email addresses from the email message to a data structure (e.g., data structure 113a) containing a mapping between email addresses and corresponding email apps. Based on the source email address being found in the data structure (186), the email application corresponding to the source email address in the data structure is executed for the email message. Otherwise, control passes to 190 in which the method determines whether the destination email address is in the data structure. Based on the destination email address being in the data structure, the method comprises at 192 causing the email application corresponding to the destination email address to be executed for the email message.

In some embodiments, even if the source email address from the email message is found in the data structure, and its corresponding email application is executed, the method also checks for the presence of the destination email address in the data structure. In such embodiments, it is possible, therefore, that more than one email application is executed based on both the source and destination email addresses being present in the data structure. In other embodiments, even if both the source and destination email addresses are present in the data structure, only one of their corresponding email applications is executed (e.g., only the application associated with the source email address or only the application associated with the destination email address).

FIG. 6 shows a method 200 in accordance with various embodiments for implementing the Re-Route App explained above. The various actions shown in FIG. 6 may be performed by the hardware processor 108 of FIG. 1 upon execution of the machine-readable instructions 112. The actions can be performed in the order shown in FIG. 6, or in a different order, and two or more of the actions can be performed in parallel as desired. FIG. 7 illustrates a data structure 113b that may be used to specify a new destination email address to be used in place of the current destination email address in the email message. In the example data structure 113b of FIG. 7, each entry 207 in the data structure contains a source email address, a destination email address and a replacement destination email address.

At 202, the method includes receiving an email message destined for a first email printer and having a first destination email address. At 204, the method includes modifying the email message to replace the first destination email address with a second destination email address of a second email printer. The action of block 204 may include examining the data structure 113b to find an entry that matches the email message's source and/or destination address and, if a match is found, replacing the current destination email address with a replacement destination email from the matching data structure entry. At 206, the modified email message is re-routed to the second destination email address of the second email printer.

FIG. 8 shows a method 210 in accordance with various embodiments. The various actions shown in FIG. 7 may be performed by the hardware processor 108 of FIG. 1 upon execution of the machine-readable instructions 112. The actions can be performed in the order shown in FIG. 8, or in a different order, and two or more of the actions can be performed in parallel as desired.

At 212, the method comprises receiving an email message to be printed by an email printer. At 214, the source and/or destination email address contained in the email message is compared to a data structure that maps email addresses to email applications. At 216, the method includes determining, from the data structure, that least two email applications are to be executed based on the results of the comparison. An email application may map to the source email address contained in the email message and another email application may map to the destination email address from the email message (e.g., as shown in FIG. 3). Alternatively or additionally, more than one email application may be mapped by the data structure to a single source or destination email address. At 218, the email applications determined from 216 are executed for the email message.

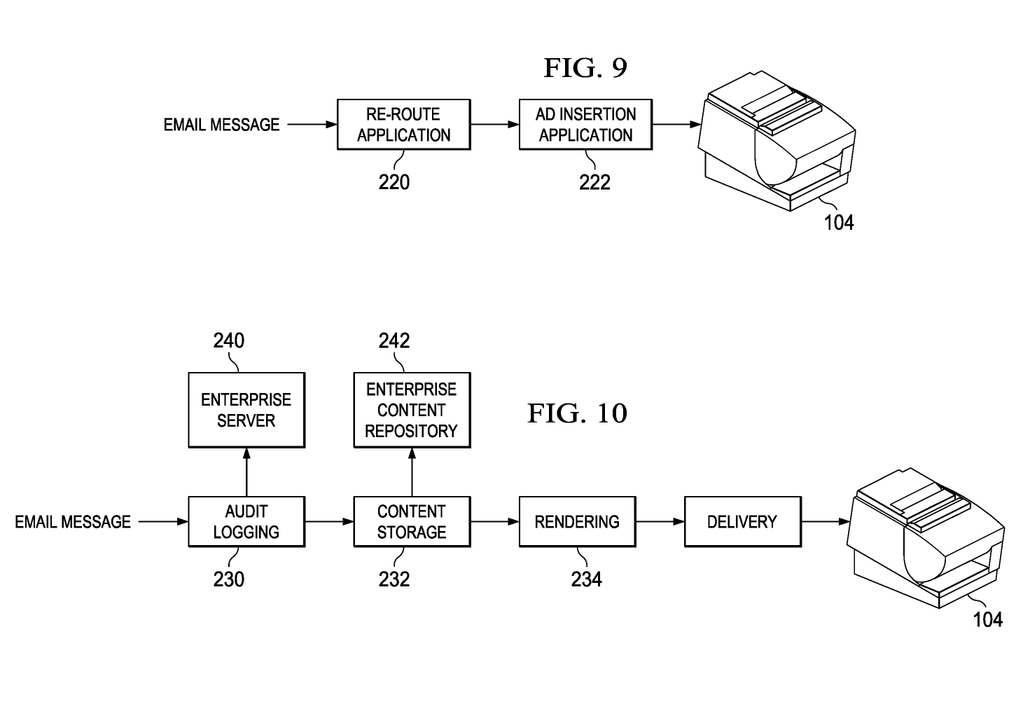

FIG. 9 illustrates the operation of the method 210 of FIG. 8. A particular email message is analyzed as in actions 214 and 216 above, the result of which is that both the Re-Route App and the Ad Insertion App are executed at 220 and 222, respectfully, as shown.

FIG. 10 shows an example in which email applications are selected for execution as a result, for example, of method 210 in FIG. 8. The email applications selected to be executed in FIG. 10 may or may not alter in some way the email message itself. For example, an audit logging application 230 may cause audit logging to be performed by an enterprise server 240. Audit logging may entail logging a history of such items as which users or email client devices initiated print jobs, the number of pages that were printed, etc. Further, FIG. 10 shows that a content storage application 232 may be executed to cause content from the email message to be stored at an enterprise content repository 242. A rendering application 234 may also execute before the email message is delivered to the target email printer.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A machine-readable storage device containing machine-readable instructions that, when executed by a processor, cause the processor to:
receive an email message destined for an email printer;
select an ad based on a parameter contained in said email message;
insert said selected ad into said email message; and
transmit said email message for printing.

2. The machine-readable storage device of claim 1 wherein said parameter comprises at least one of a destination email address of the email printer and a source email address.

3. The machine-readable storage device of claim 1 wherein said machine-readable instructions, when executed by the processor, cause the processor to re-route said email message, with inserted selected ad, to a printer different than the email printer.

4. The machine-readable storage device of claim 1 wherein said machine-readable instructions, when executed by the processor, cause the processor to replace a destination email address with a different email address.

5. A method, comprising:
receiving an email message containing a source email address and a destination email address of an email printer;
comparing said source and destination email addresses to a data structure containing a mapping between email addresses and corresponding email applications;
based on said source email address contained in said data structure, causing the application corresponding to said source email address to be executed for said email message; and
based on said destination email address contained in said data structure, causing the application corresponding to said destination email address to be executed for said email message.

6. The method of claim 5 wherein at least one of the applications comprises an application to perform at least one of audit logging, content storage and rendering.

7. The method of claim 5 wherein at least one of the applications comprises an application to insert an ad in said email message.

8. The method of claim 5 wherein at least one of the applications comprises an application to reroute said email message to a different email printer.

9. The method of claim 5 wherein at least one of the applications comprises an application to modify said email message to a different email printer, said different email printer selected based on at least one of the source and destination email addresses.

10. The method of claim 5 wherein at least one of the applications comprises an application to at least one of perform image enhancement and ad removal.

11. The method of claim 5 wherein at least one of the applications comprises an application to reconfigure a user preference.

12. A machine-readable storage device containing machine-readable instructions that, when executed by a processor, cause the processor to:
receive an email message destined for a first email printer having a first destination email address;
modify said email message to replace said first destination email address with a second destination email address of a second email printer; and
reroute said email message to said second destination email address of said second email printer.

13. The machine-readable storage device of claim 12 wherein said machine-readable instructions, when executed by a processor, cause the processor to modify said email message by examining a data structure for an entry that matches a parameter of the email message and retrieving the second destination email from a matching entry.

14. The machine-readable storage device of claim 12 wherein the parameter comprises at least one of source email address in the email message and the first destination email address.
